(19) United States
(12) Patent Application Publication
(10) Pub. No.: US 2014/0314453 A1
(43) Pub. Date: Oct. 23, 2014

(54) DEVELOPING UNIT AND IMAGE FORMING APPARATUS USING THE SAME

(71) Applicant: Samsung Electronics Co., Ltd., Suwon-si (KR)

(72) Inventors: Jeong Hyun Lee, Busan (KR); Young Jin Park, Masan-Si (KR); Jong Woo Lee, Suwon Si (KR)

(73) Assignee: Samsung Electronics Co., Ltd., Suwon-si (KR)

(21) Appl. No.: 14/255,247

(22) Filed: Apr. 17, 2014

(30) Foreign Application Priority Data
Apr. 23, 2013 (KR) 10-2013-0044633

(51) Int. Cl. G03G 15/08

(52) U.S. Cl. CPC G03G 15/0865
USPC 399/284

(57) ABSTRACT

A developing unit and an image forming apparatus using the may include a photosensitive body having an electrostatic latent image formed thereon, a feed roller to supply a developing agent, a regulating member to regulate the amount of the developing agent transported to the developing member, and a protection member having a protection blade disposed at one side of the regulating member to be spaced apart from the regulating member to protect the regulating member. The regulating member may be prevented from being damaged or degraded and protected from an external environment.

### CROSS-REFERENCE TO RELATED APPLICATIONS

This application claims the priority benefit of Korean Patent Application No. 10-2013-0044633, filed on Apr. 23, 2013 in the Korean Intellectual Property Office, the disclosure of which is incorporated herein by reference.

### BACKGROUND

1. Field

Embodiments relate to a developing unit having a constituent with an improved structure to regulate transport of a developing agent and an image forming apparatus using the same.

2. Description of the Related Art

An image forming apparatus forms an image on a printing medium according to an input signal. Examples of such an image forming apparatus include a printer, a copier, a facsimile machine, and a multifunction device combining functions of the above-mentioned appliances.

In an image forming apparatus adopting electrophotography, an electrostatic latent image is first formed on the surface of a photosensitive body charged with a predetermined electric potential by emitting light onto the photosensitive body, and then a developing agent is supplied onto the electrostatic latent image to form a visible developing agent image. The developing agent image formed on the photosensitive body is directly transferred to the printing medium or is transferred to the printing medium via an intermediate transfer body. The transferred image is fixed to the printing medium through the fusing operation.

A developing agent is supplied to the photosensitive body using a member to transport the developing agent. At this time, to regulate the thickness of the developing agent attached to the member, a regulating member is provided.

### SUMMARY

According to an aspect of one or more embodiments, there is provided a developing unit with improved durability against shock and which may enhance productivity, and an image forming apparatus using the same.

In an aspect of one or more embodiments, there is provided a developing unit which includes a developing unit housing, a developing member provided in the developing unit housing to transport a developing agent supplied thereto to a photosensitive body having an electrostatic latent image formed thereon, a regulating member to regulate the amount of the developing agent transported to the developing member, and a protection member disposed at an upper or lower portion of the regulating member to be spaced apart from the regulating member to protect the regulating member.

The regulating member may include a regulating portion provided at an end of the regulating member to adjoin the developing member to regulate the amount of the developing agent transported to the developing member, and the protection member comprises a blade portion and a protection portion extending from the blade portion.

The protection portion may be formed to bend from the blade portion toward the regulating member.

At least one part of the blade portion may be parallel with the regulating member.

At least one part of the blade portion may be spaced a first distance from the regulating member.

The developing unit may further include a pair of sealing members provided at both ends of the developing member to prevent leakage of the developing agent.

The protection member may further include a pair of pressing units to cause the sealing member and the developing member to closely contact each other.

An end of each of the pressing units may bend toward the developing member.

The protection member may further include a slit to divide the pressing unit and protection portion.

Opposite ends of the blade portion may be supported by the pressing units.

At least one portion of the regulating member may bend toward the developing member, and at least one portion of the blade portion may bend in a direction in which the developing member bends.

The regulating member may include a body formed in a plate shape to extend along the developing member, a regulating portion provided at one end of the body and bending along a direction of rotation of the developing member, a support provided at the other end of the body to support the body, and a bent portion arranged between the regulating portion and the support to bend toward the developing member.

The developing unit may further comprise a regulating member bracket mounted to the developing unit housing, wherein the regulating member bracket may be fixed to one end of the regulating member.

In an aspect of one or more embodiments, there is provided an image forming apparatus which includes a body, a photosensitive body rotatably mounted in the body, and a developing unit comprising: a developing member arranged to face the photosensitive body to transport a developing agent to the photosensitive body; a regulating member to regulate the amount of the developing agent supported on a surface of the developing member; and a protection member provided at an upper or lower portion of the regulating member to protect the regulating member.

In an aspect of one or more embodiments, there is provided a developing unit which includes a housing, a developing agent storage portion provided in the housing to store the developing agent, a developing member to receive the developing agent from the developing agent storage portion and transport the received developing agent to the photosensitive body, an electrostatic latent image being formed on the photosensitive body, a regulating member provided with one end fixed to the housing and the other end to contact the developing member, and installed in a trail manner, and a protection member disposed at an upper or lower portion of the regulating member to be spaced apart from the regulating member to protect the regulating member.

### BRIEF DESCRIPTION OF THE DRAWINGS

These and/or other aspects of embodiments will become apparent and more readily appreciated from the following description of exemplary embodiments, taken in conjunction with the accompanying drawings of which:

FIG. 1 is a view showing the configuration of an image forming apparatus according to an exemplary embodiment;

FIG. 2 is a view showing some constituents of the image forming apparatus of FIG. 1;

FIG. 3 is a perspective view showing a developing unit according to an embodiment;

FIG. 4 is an exploded perspective view of the developing unit of FIG. 3;

FIG. 5 is a view showing a protection member of the developing unit of FIG. 3;

FIG. 6A is a cross-sectional view showing the developing unit of FIG. 3, taken along line A-A′; and

FIG. 6B is a cross-sectional view showing the developing unit of FIG. 3, taken along line B-B′.

### DETAILED DESCRIPTION

Reference will now be made in detail to embodiments, examples of which are illustrated in the accompanying drawings, wherein like reference numerals refer to like elements throughout.

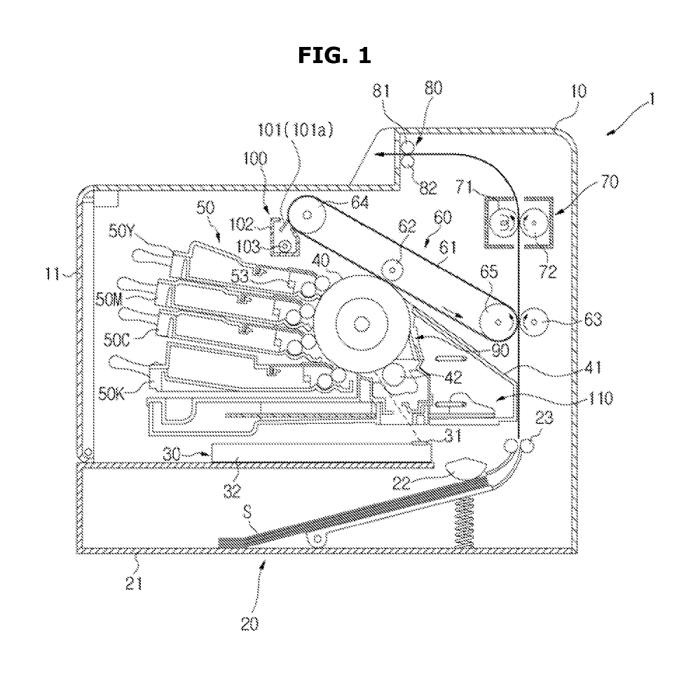

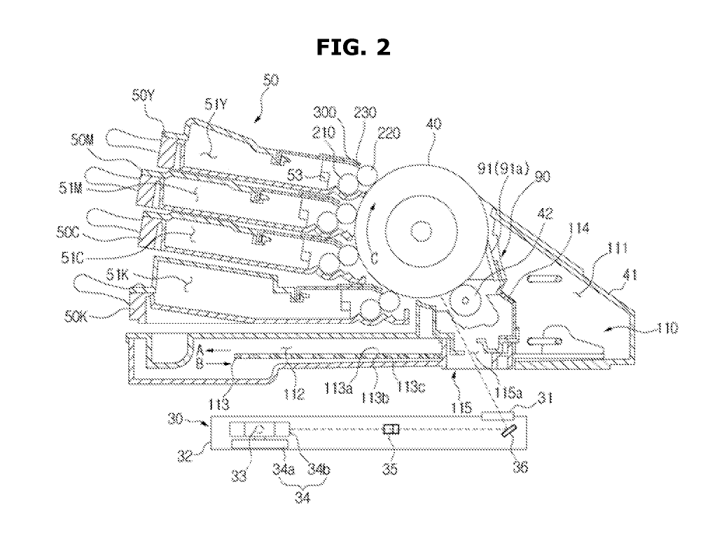

FIG. 1 is a view showing the configuration of an image forming apparatus according to an exemplary embodiment and FIG. 2 is a view showing some constituents of the image forming apparatus of FIG. 1.

As shown in FIGS. 1 and 2, the image forming apparatus 1 includes a body 10, a printing medium feed unit (print medium feeder) 20, an optical scanner 30, a photosensitive body 40, a developing unit (developer) 50, a transfer unit 60, a fusing device 70, and a printing medium discharge unit (printing medium discharger) 80.

The body 10 forms an external appearance of the image forming apparatus 1 and supports various components installed therein. A body cover 11 is rotatably installed at one side of the body 10. The body cover 11 opens and closes a portion of the body 10. The body cover 11 allows a user to reach inside of the body 10 to install or remove various components including the developing unit 50 therethrough.

The printing medium feed unit 20 includes a cassette 21 to store the printing media S, a pickup roller 22 to pick up the printing media S stored in the cassette 21 one by one, and a transport roller 23 to transport a printing medium having been picked up toward the transfer unit 60.

The optical scanner 30 forms an electrostatic latent image on the surface of the photosensitive body 40 by projecting light onto the photosensitive body 40. When the image forming apparatus 1 performs printing operation, the optical scanner 30 projects light corresponding to the image information onto the photosensitive body 40.

The optical scanner 30 includes a case 32 provided with a light transmission member 31 to transmit light to the outside, and an optical scanning system mounted in the case 32.

The optical scanning system includes a light source 33 to emit light, an optical deflector 34 to deflect light emitted from the light source 33, an f-theta lens 35 to correct aberrations in the light deflected by the optical deflector 34, and a reflector 36 to reflect light transmitted through the f-theta lens 35 to the photosensitive body 40.

The optical deflector 34 includes a driving motor 34a, and a polygonal mirror 34b rotated by the driving motor 34a. The polygonal mirror 34b is provided with a plurality of reflective surfaces on the lateral surface thereof to perform biased scanning of light transmitted from the light source 33.

Light emitted from the light source 33 is deflected by the rotating polygonal mirror 34b, and reflected by the reflector 36 to the light transmission member 31 via the f-theta lens 35. The light reflected from the reflector 36 is transmitted through the light transmission member 31 to the outside of the case 32 and applied to the photosensitive body 40, thereby forming an electrostatic latent image on the surface of the photosensitive body 40. The light transmission member 31 may be formed of transparent glass or plastic. Alternatively, a slit-shaped space through which light is transmitted may be provided in place of the light transmission member 31.

The photosensitive body 40 is an image carrier to carry the electrostatic latent image formed by the optical scanner 30 and the developing agent image formed by the developing unit 50. In this embodiment, the photosensitive body 40 is of a cylindrical drum type. Alternatively, the photosensitive body 40 may be of a belt type that rotates around a caterpillar track.

The photosensitive body 40 of this embodiment is rotatably installed in a photosensitive body housing 41, which is detachably mounted to the body 10. Alternatively, the photosensitive body 40 may be fixed to the body 10. A charging member 42 is installed in the photosensitive body housing 41. The charging member 42 charges the photosensitive body 40 to a predetermined electric potential before light is emitted from the optical scanner 30. Depending on embodiments, the charging member 42 may be formed as a cylindrical roller, a corona involving a conductive wire, or a plate involving a conductive plate.

The developing unit 50 forms a visible developing agent image by supplying a developing agent to the photosensitive body 40 having an electrostatic latent image formed thereon. The developing unit 50 may include four developing devices 50K, 50C, 50M and 50Y to respectively contain developing agents of different colors, e.g., black, cyan, magenta and yellow. Hereinafter, when it is necessary to distinguish the developing devices 50K, 50C, 50M and 50Y from each other, they will be respectively referred to as a black developing device 50K, a cyan developing device 50C, magenta developing device 50M, and yellow developing device 50Y.

The developing devices 50K, 50C, 50M and 50Y may be disposed adjacent and parallel to each other along the direction of rotation (direction C) of the photosensitive body 40. In FIG. 2, the black developing device 50K, cyan developing device 50C, magenta developing device 50M, and yellow developing device 50Y are disposed, in this order, along the direction of rotation of the photosensitive body 40. However, embodiments are not limited thereto. The order of disposition of the developing devices 50K, 50C, 50M and 50Y may be changed as necessary.

Each of the developing devices 50K, 50C, 50M and 50Y has a developing agent storage portion 51 K, 51C, 51 M, 51Y, a feed roller 210, and a developing member 220. In FIG. 2, only the feed roller and developing member installed at the developing device 50Y are indicated by reference numerals of 210 and 220 for convenience of description.

A developing agent to be supplied to the photosensitive body 40 is stored in the developing agent storage portions 51 K, 51C, 51 M, 51Y. The feed roller 210 feeds the developing agent stored in the developing agent storage portions 51 K, 51C, 51M, 51Y to the developing member 220. Depending on the configuration of the developing devices 50K, 50C, 50M, 50Y, the feed roller 210 may be of a roller type or a plate type. Alternatively, the feed roller 210 may be omitted. The developing member 220 forms a visible image by attaching the developing agents to the photosensitive body 40 having an electrostatic latent image formed thereon. In this embodiment, the developing member 220 is formed of rubber or metal in a cylindrical shape. Alternatively, it may be formed in a belt or tubular shape.

The developing agent storage portion may be provided with at least one churning blade 53 to prevent solidification of the developing agent stored therein.

The transfer unit 60 may include an intermediate transfer belt 61, a first transfer roller 62, and a second transfer roller 63.

The intermediate transfer belt 61 is supported by support rollers 64 and 65, and is adapted to travel at the same speed as the linear speed of the photosensitive body 40. The first transfer roller 62 is arranged to face the photosensitive body 40 with the intermediate transfer belt 61 placed between the first transfer roller 62 and the photosensitive body 40 such that the developing agent image formed on the photosensitive body 40 is transferred to the intermediate transfer belt 61.

The second transfer roller 63 faces the support roller 65 with the intermediate transfer belt 61 placed between the second transfer roller 63 and the support roller 65. The second transfer roller 63 is arranged spaced from the intermediate transfer belt 61 during transfer of an image from the photosensitive body 40 to the intermediate transfer belt 61, and arranged to contact the intermediate transfer belt 61, applying a predetermined pressure once the image on the photosensitive body 40 is completely transferred to the intermediate transfer belt 61. The image on the intermediate transfer belt 61 is transferred to the printing medium when the second transfer roller 63 contacts the intermediate transfer belt 61.

As shown in FIGS. 1 and 2, the image forming apparatus 1 may include a first cleaning unit 90 to clean the developing agent remaining in the photosensitive body 40, a second cleaning unit 100 to clean the developing agent remaining on the intermediate transfer belt 61, and a waste developing agent storage unit 110 to store waste developing agent recovered from the photosensitive body 40.

The first cleaning unit 90 includes a cleaning unit disposed to contact the photosensitive body 40. The cleaning unit scrapes off developing agent remaining on the surface of the photosensitive body 40 by making a frictional contact with the photosensitive body 40. The cleaning unit may include a cleaning blade 91a installed in the photosensitive body housing 41 and having one end contacting the photosensitive body 40.

The second cleaning unit 100 includes a cleaning unit 101 disposed to contact the intermediate transfer belt 61, a waste developing agent collection box 102 to temporarily store waste developing agent recovered from the intermediate transfer belt 61 by the cleaning unit 101, and a transport unit 103 to transport the waste developing agent collected in the waste developing agent collection box 102.

The cleaning unit 101 may include a cleaning blade 101a having one end to make a frictional contact with the intermediate transfer belt 61 to scrape off the developing agent remaining on the surface of the intermediate transfer belt 61. In addition, the transport unit 103 may include an auger provided with a spiral blade to transport the waste developing agent by rotating.

In FIGS. 1 and 2, the cleaning blades 91a and 101a are applied as the cleaning unit 101. Alternatively, a cleaning unit of a brush type or a roller type may be applied as the cleaning unit.

The waste developing agent storage unit 110 may include a first waste developing agent storage portion 111, a second waste developing agent storage portion 112, and a waste developing member 113.

The first waste developing agent storage portion 111 and the first waste developing agent storage portion 111 are arranged in the photosensitive body housing 41. A support member 114 is installed at one side of the first waste developing agent storage portion 111, and the cleaning blade 91a is fixed to an end of the support member 114. The waste developing agent removed from the photosensitive body 40 by the cleaning blade 91a is stored in the first waste developing agent storage portion 111, and is transported to the second waste developing agent storage portion 112 by the waste developing member 113.

An optical window 115 is provided between the first waste developing agent storage portion 111 and second waste developing agent storage portion 112. The optical window 115 is provided with a light transmission hole 115a penetrating the photosensitive body housing 41 to allow light projected from the optical scanner 30 to reach the photosensitive body 40 through the photosensitive body housing 41.

In addition, a developing agent movement path (not shown) is provided between the first waste developing agent storage portion 111 and second waste developing agent storage portion 112. The developing agent movement path (not shown) allows the developing agent stored in the first waste developing agent storage portion 111 to move to the second waste developing agent storage portion 112 along both sides of the optical window 115.

The waste developing member 113 is installed in the photosensitive body housing 41 such that the waste developing member 113 is rectilinearly movable. The waste developing member 113 transports the waste developing agent stored in the first waste developing agent storage portion 111 and the second waste developing agent storage portion 112 in the direction A by reciprocating in the directions A and B indicated by arrows in FIG. 2.

The waste developing member 113 includes transport ribs 113a spaced apart from each other. One lateral surface 113b of each transport rib facing in the transport direction of the waste developing agent, i.e., the direction A, is formed as a vertical surface for effective transport of the waste developing agent. On the other hand, the other lateral surface 113c on the opposite side of the one lateral surface 113b may be formed as an inclined surface to minimize backward movement of the waste developing agent when the transport rib 113a moves in the direction opposite to the transport direction of the waste developing agent.

As shown in FIG. 1, the fusing unit 70 may include a heating roller 71 having a heat source, and a pressing roller 72 installed to face the heating roller 71. When the printing medium passes through the space between the heating roller 71 and the pressing roller 72, the image is fixed to the printing medium by heat transferred from the heating roller 71 and pressure applied to the printing medium by the heating roller 71 and the pressing roller 72.

The printing medium discharge unit 80 is provided with a discharge roller 81 and a discharge backup roller 82 to discharge a printing medium having passed through the fusing unit 70 from the body 10.

Hereinafter, operation of an image forming apparatus configured as above will be described with reference to FIGS. 1 and 2.

When printing operation starts, the surface of the photosensitive body 40 is uniformly charged by the charging member 42. Then, light corresponding to information about an image of one color, for example, yellow, from the optical scanner 30 is projected onto the uniformly charged surface of the photosensitive body 40. Thereby, an electrostatic latent image corresponding to yellow is formed on the photosensitive body 40.

Subsequently, a developing bias voltage is applied to the developing member 220 of the yellow developing device 50Y. Thereby, the yellow developing agent is attached to the electrostatic latent image, and thus a yellow developing agent image is formed on the photosensitive body 40. The formed developing agent image is transferred to the intermediate transfer belt 61 by the first transfer roller 62.

When transfer of the yellow image for one sheet is completed, the optical scanner 30 projects light corresponding to an image of another color, for example, magenta, onto the photosensitive body 40, forming an electrostatic latent image corresponding to the magenta image. Then, the magenta developing device 50M supplies the magenta developing agent to the electrostatic latent image to form a developing agent image. The magenta developing agent image formed on the photosensitive body 40 is transferred to the intermediate transfer belt 61 by the first transfer roller 62. At this time, the magenta developing agent image overlaps the previously transferred yellow developing agent image.

Once the same operations are performed for cyan and black, a color image created by overlapping of the yellow, magenta, cyan, black images is formed on the intermediate transfer belt 61. The finished color image is transferred to the printing medium passing through the space between the intermediate transfer belt 61 and the second transfer roller 63, and the printing medium is discharged from the body 10 via the fusing unit 70 and the printing medium discharge unit 80.

In the printing operation as above, some of the developing agents remains on the photosensitive body 40 or the intermediate transfer belt 61 as waste developing agent when the developing agent images are transferred to the intermediate transfer belt 61 or to the printing medium. These waste developing agents are removed by the cleaning blades 91a and 101a in frictional contact with the photosensitive body 40 and the intermediate transfer belt 61.

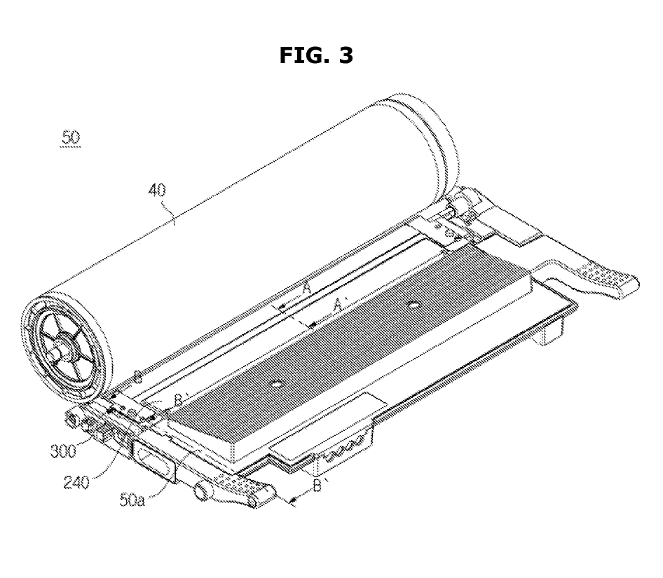

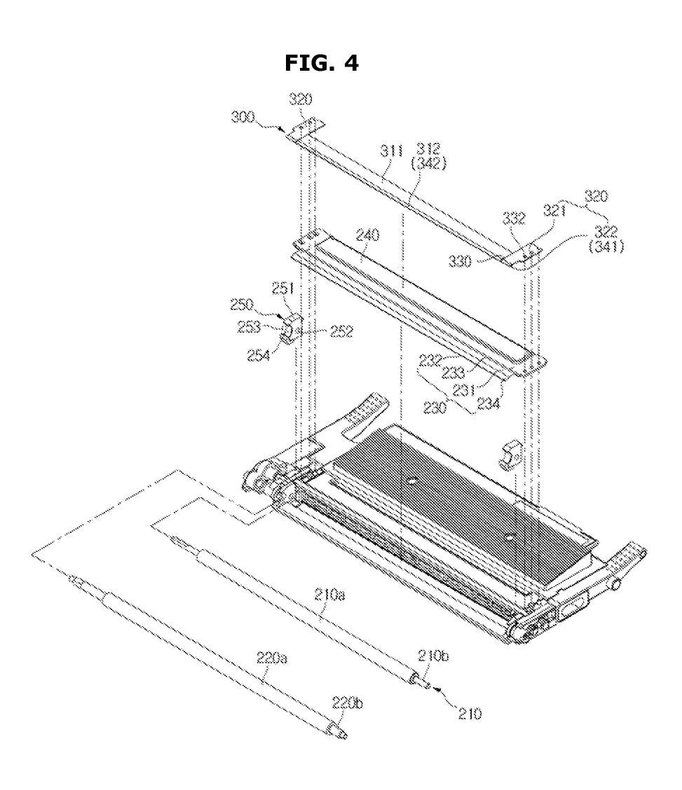

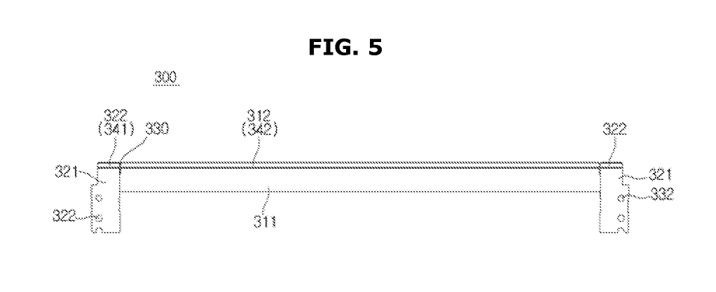

FIG. 3 is a perspective view showing a developing unit according to an embodiment, FIG. 4 is an exploded perspective view of the developing unit of FIG. 3, and FIG. 5 is a view showing a protection member of the developing unit of FIG. 3.

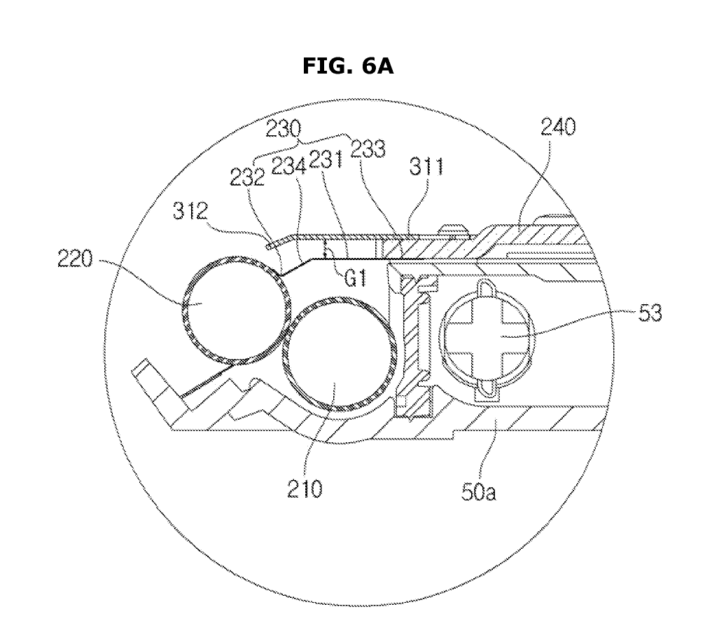

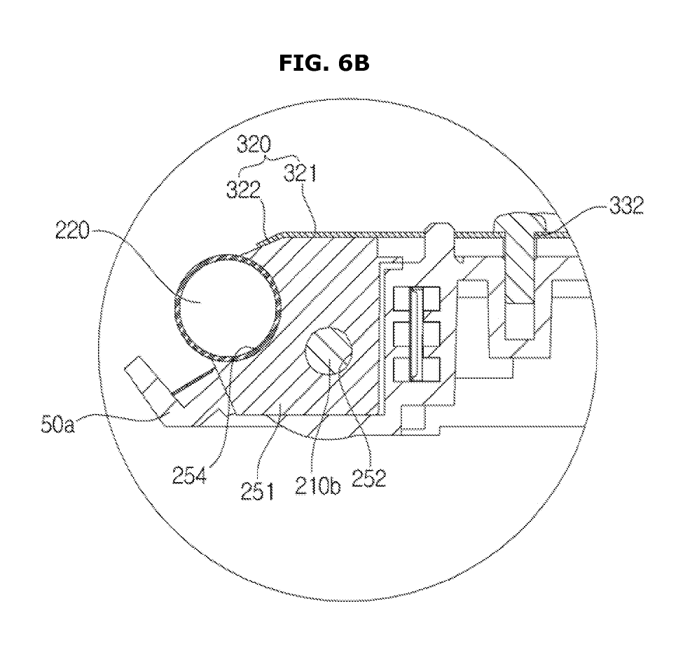

FIG. 6A is a cross-sectional view showing the developing unit of FIG. 3, taken along line A-A′, and FIG. 6B is a cross-sectional view showing the developing unit of FIG. 3, taken along line B-B′.

The developing unit 50 may include a developing unit housing 50a, a feed roller 210, a developing member 220, a regulating member 230, and a protection member 300.

The developing unit housing 50a forms an external appearance of the developing unit 50, and may be provided therein with constituents such as a feed roller 210 and a developing member 220.

The developing member 220 forms a visible image by attaching the developing agents to the photosensitive body 40 having an electrostatic latent image formed thereon. In this embodiment, the developing member 220 is formed of rubber or metal in a cylindrical shape. Alternatively, it may be formed in a belt or tubular shape.

The developing member 220 may include a developing agent transport part 220a to which a developing agent is attached and which has a cylindrical lateral surface, and a developing member support 220b which supports the developing member 220 and serves as a center of rotation of the developing member 220.

The feed roller 210 may include a feed roller surface 210a to supply a developing agent in the developing agent storage portion to the developing member 220, and a feed roller support 210b to support the feed roller 210 and functioning as the center of rotation of the feed roller 210.

A sealing member 250 may be provided at the ends of the feed roller 210 and the developing member 220. The sealing member 250 may be provided at an end of the developing member 220 to prevent the developing agent from leaking along the surface of the developing member 220.

Specifically, the sealing member 250 may include a sealing member body 251, a feed roller hole 252 provided on the sealing member body 251 and allowing the support of the feed roller 210 to pass therethrough, and a seating portion 253 provided on the sealing member body 251 and allowing an end of the developing member 220 to be seated thereon. The seating portion 253 may have a circular shape provided with an open portion to allow a portion of the developing member 220 to be inserted thereinto and seated.

A seating press portion 254 is provided on the outer surface of the seating portion 253 such that the developing member 220 closely contacts the sealing member 250. Both ends of the developing agent transport part 220a are inserted into and seated in the seating portion 253 of the sealing member 250. As both ends of the developing agent transport part 220a closely contact the seating press portion 254, leakage of the development agent through the ends may be prevented.

A regulating member 230 is provided such that one side thereof contacts the developing member 220 to regulate the amount of the developing agent transported through the developing member 220.

The regulating member 230 may be installed in a ‘counter’ manner or in a ‘trail’ manner. In the counter manner, the regulating member 230 is installed such that the leading edge of the regulating member 230 contacting the developing member 220 faces in a direction opposite to the direction of rotation of the developing roller. In the trail manner, the regulating member 230 is installed such that the leading edge of the regulating member 230 contacting the developing member 220 faces in the direction of rotation of the developing roller.

The counter manner of installation may be advantageous in that it allows uniform formation of the layer of developing agent and provides good performance of sealing of the developing unit. However, the regulating member 230 installed in this manner may be structurally disadvantageous in designing a compact developing unit. On the other hand, the trail manner is advantageous in miniaturizing the developing unit. However, when the regulating member 230 is installed in this manner, the regulating member 230 may fail to maintain proper strength and elasticity. Thereby, the performance of controlling the layer of the developing agent and sealing the developing unit may be lower than in the counter manner.

Since forming the image forming apparatus to have a compact size has become increasingly important in product development, the trail manner may be greatly advantageous in realizing a compact image forming apparatus. Hereinafter, an embodiment employing the trail manner will be described, while the counter manner is also applicable to other embodiments.

The regulating member 230 may include a body 231, a regulating portion 232, a support 233, and a bent portion 234.

The body 231 may be arranged in a plate shape extending along the developing member 220. The support 233 is arranged at one side of the body 231, and the bent portion 234 is arranged at the other side of the body 231.

The bent portion 234 may be formed to extend from the body 231. The bent portion 234 is formed on the body 231 to be bent toward the developing member 220. The bent portion 234 may assist the regulating portion 232, which will be described later, in bearing force applied by rotation of the developing member 220.

The support 233 serves to fix the regulating member to the developing unit 50. The support 233 may be directly coupled to the developing unit 50 to support the regulating member, or may be provided to a regulating member bracket 240 provided to the developing unit 50 to support the regulating member. In this embodiment, the support 233 is coupled to the regulating member bracket 240 to support the regulating member 230.

The regulating portion 232 is arranged at one end of the developing member 220 of the body 231, more specifically, at the end of the bent portion 234. In addition, the regulating portion 232 may be formed to extend from the bent portion 234.

The regulating portion 232 contacts the developing member 220 or moves to be spaced apart from the developing member 220 depending on the amount of the developing agent being transported to regulate the transported amount of the developing agent. The shape of the regulating portion 232 is not restricted. In this embodiment, the regulating portion 232 is formed to have an end bent in the direction of rotation of the developing member 220.

The protection member 300 serves to protect the regulating member 230. The regulating member 230 and the developing member 220 stay in contact with each other or are spaced a predetermined distance apart from each other to regulate the mount of the developing agent. In the case that the regulating member 230 adapted to regulate the amount of the developing agent transported to the photosensitive body 40 via the developing member 220 is damaged or a part thereof becomes poor, regulation of the transported developing agent may not be properly performed. Accordingly, the regulating member 230 is protected.

The protection member 300 may include a blade portion 311 and a protection portion 312.

The blade portion 311 and protection portion 312, which serve to protect the regulating member 230, may guide one side of the regulating member 230 such that the regulating member 230 is not exposed.

Both ends of the blade portion 311 are supported by the pressing unit 320, which will be described later. The blade portion 311 is arranged such that at least one portion thereof is parallel with the protection member 300. In the illustrated embodiment, the blade portion 311 is supported by the pressing unit 320. Alternatively, the blade portion 311 may be directly coupled to the developing unit housing.

The blade portion 311 may be disposed spaced a first gap G1 from the regulating member 230, in consideration of occurrence of vibration by shock applied to the protection member 300 by external force.

The first gap G1 is not restricted, and may be varied depending on the capacity and size of the developing unit 50.

The protection portion 312 may extend from the blade portion 311, or may be bent from the blade portion 311. The protection portion 312 may be bent toward the regulating member 230. The protection portion 312 may be parallel with the bent portion 234 of the regulating member 230, or may be non-parallel with and spaced apart from the bent portion 234 as shown in FIG. 6A.

The angle and direction of bending of the protection portion 312 may be adjusted according to the angle and direction of bending of the bent portion 234 of the regulating member 230, so long as the protection portion 312 is bent in the same direction as the bent portion 234.

The length of the protection portion 312 is not restricted so long as the protection portion 312 does not contact the developing member 220 and the regulating portion 232 of the regulating member 230 is protected from external shock or unexposed.

The protection member 300 may further include a pressing unit 320.

The pressing unit 320, which serves to cause the sealing member 250 and the developing member to closely contact each other, may be configured to contact one side of the sealing member 250.

The pressing unit 320 may include a pressing unit body 321 and a pressing portion 322.

The pressing unit body 321 is provided with a fastening portion 332 to be coupled to the developing unit housing 50a. Specifically, the pressing unit body 321 may be fixed to both lateral surfaces of the regulating member bracket 240, by which the regulating member 230 is supported.

One side of the pressing unit body 321 is coupled and fixed to the developing unit housing 50a or the regulating member bracket 240, and the other side thereof closely contacts one side of the sealing member 250 to apply pressure to one surface of the sealing member 250.

The pressing portion 322 may extend from the pressing unit body 321. The pressing portion 322 may be bent from the pressing unit body 321 to apply pressure to the seating press portion 254 of the sealing member 250.

The protection member 300 may include a pressing unit 320, a blade portion 311 and a protection portion 312. The protection member 300 may be formed approximately in a bracket shape. That is, the pressing unit 320 may be disposed at both ends of the protection member 300 to be integrally supported at the pressing unit 320 or to have both ends thereof supported at the pressing unit 320, such that the blade portion 311 and protection portion 312 may be disposed.

A slit 330, i.e., a space to divide the protection portion 312 and the pressing portion 322 of the pressing unit 320 may be formed between the protection portion 312 and the pressing portion 322. With the slit 330, the protection portion 312 of the protection member 300 and the pressing portion 322 may have different rates of bending and different functions.

The angle and direction of bending of the pressing portion 322 of the pressing unit 320 may be the same as or different from those of the protection portion 312, so along as the pressing portion 322 and the protection portion 312 fulfill their functions.

The protection member 300 may include a bent portion provided at a side end of the developing member 220 and bent toward the developing member 220. The bent portion may include a slit 330 to divide the pressing unit 320 and the protection blade 310 from each other.

The bent portion may include a first bent portion 341 separated by the slit 330 and provided at an end of the pressing unit 320, and a second bent portion 342 arranged at an end of the blade portion 311.

The first bent portion 341 may be formed to press the upper end of the sealing member 250 to cause the sealing member and the developing member 220 to closely contact each other. The second bent portion 342 may be provided on the top of the bent portion 234 and regulating portion 232, which are bent from the regulating member 230 toward the developing member 220, to protect the regulating member.

The angle and direction of bending of the first bent portion 341 may be the same as or different from those of the second bent portion 342, so long as the first bent portion 341 and the second bent portion 342 fulfill their functions.

As is apparent from the above description, a developing unit and an image forming apparatus using the same according to an embodiment may have improved durability against external physical shock and reduce quality degradation of a product due to shock during manufacture or mishandling thereof by a user, thereby enhancing productivity and providing easy handling of the product.

Although a few embodiments have been shown and described in the present disclosure, it would be appreciated by those skilled in the art that changes may be made in these embodiments without departing from the principles and spirit of the disclosure, the scope of which is defined in the claims and their equivalents.

What is claimed is:

1. A developing unit comprising:
a developing unit housing;
a developing member provided in the developing unit housing to transport a developing agent supplied thereto to a photosensitive body having an electrostatic latent image formed thereon;
a regulating member to regulate an amount of the developing agent transported through the developing member; and
a protection member disposed at an upper or lower portion of the regulating member to be spaced apart from the regulating member to protect the regulating member.

2. The developing unit according to claim 1, wherein:
the regulating member comprises a regulating portion provided at an end of the regulating member to adjoin the developing member to regulate the amount of the developing agent transported to the developing member; and
the protection member comprises a blade portion and a protection portion extending from the blade portion.

3. The developing unit according to claim 2, wherein the protection portion is formed to bend from the blade portion toward the regulating member.

4. The developing unit according to claim 2, wherein at least one part of the blade portion is parallel with the regulating member.

5. The developing unit according to claim 2, wherein at least one part of the blade portion is spaced a first distance from the regulating member.

6. The developing unit according to claim 2, further comprising a pair of sealing members provided at both ends of the developing member to prevent leakage of the developing agent.

7. The developing unit according to claim 6, wherein the protection member further comprises a pair of pressing units to cause the sealing member and the developing member to closely contact each other.

8. The developing unit according to claim 7, wherein an end of each of the pressing units bends toward the developing member.

9. The developing unit according to claim 7, wherein the protection member further comprises a slit to divide the pressing unit and protection portion.

10. The developing unit according to claim 7, wherein opposite ends of the blade portion is supported by the pressing units.

11. The developing unit according to claim 2, wherein at least one portion of the regulating member bends toward the developing member, and at least one portion of the blade portion bends in a direction in which the developing member bends.

12. The developing unit according to claim 1, wherein the regulating member comprises:
a body formed in a plate shape to extend along the developing member;
a regulating portion provided at one end of the body and bending along a direction of rotation of the developing member;
a support provided at the other end of the body to support the body; and
a bent portion arranged between the regulating portion and the support to bend toward the developing member.

13. The developing unit according to claim 1, further comprising a regulating member bracket mounted to the developing unit housing,
wherein the regulating member bracket is fixed to one end of the regulating member.

14. An image forming apparatus comprising:
a body;
a photosensitive body rotatably mounted in the body; and
a developing unit comprising: a developing member arranged to face the photosensitive body to transport a developing agent to the photosensitive body; a regulating member to regulate the amount of the developing agent supported on a surface of the developing member; and a protection member provided at an upper or lower portion of the regulating member to protect the regulating member.

15. A developing unit comprising:
a housing;
a developing agent storage portion provided in the housing to store the developing agent;
a developing member to receive the developing agent from the developing agent storage portion and transport the received developing agent to a photosensitive body, an electrostatic latent image being formed on the photosensitive body;
a regulating member provided with one end fixed to the housing and the other end to contact the developing member, and installed so that a leading edge of the regulating member, which contacts the developing member, faces in a direction of rotation of the developing members; and
a protection member disposed at an upper or lower portion of the regulating member to be spaced apart from the regulating member to protect the regulating member.
